(19) United States
(12) Patent Application Publication
(10) Pub. No.: US 2002/0191364 A1
(43) Pub. Date: Dec. 19, 2002

(54) Sole structure for electrostatic dissipative footwear and method of making same

(76) Inventors: Chien Lee, Taipai (TW); Donald R. Jensen, Bonita Springs, FL (US)

Correspondence Address: KIRKPATRICK & LOCKHART LLP, 535 SMITHFIELD STREET, PITTSBURGH, PA, 15222, US

(21) Appl. No.: 09/814,085

(22) Filed: Mar. 21, 2001

(51) Int. Cl. H05F 3/00

(52) U.S. Cl. 361/224

(57) ABSTRACT

A sole and printed circuit assembly for an article of electrostatic dissipative footwear. The present invention also includes a method of manufacturing a sole for an article of electrostatic dissipative footwear.

### CROSS-REFERENCE TO RELATED APPLICATIONS

Not Applicable.

### FEDERALLY SPONSORED RESEARCH

Not Applicable.

### BACKGROUND OF THE INVENTION

1. Field of the Invention

The invention relates to footwear and, more particularly, to footwear constructed to dissipate electrostatic charges.

2. Description of the Invention Background

Static electricity is the accumulation of electric charge in an insulated body, most frequently caused by friction, but also by other means, such as induction etc. Electrostatic discharge (ESD) is the transfer of electric charge between two bodies, often accompanied by a visible spark, as in the familiar phenomenon of doorknob shock. While electrostatic discharge per se may not be immediately harmful to a human body, at least at level of voltage less than about 3000 volts, a discharge of much smaller voltage might be damaging to sensitive equipment, such as electronic components for computers and magnetic data carriers. A low volt electrostatic discharge may also ignite explosive gases. Accordingly, protection against ESD is required in the electronics and telecommunications industries and in other industries wherein sensitive electrical components or explosive materials are being handled.

ESD is of particular concern to the electronics industries. For example, if a quality control inspector carries a static charge during an inspection or testing operation, at a minimum, the accuracy of the test may be affected or, in worse cases, one or more sensitive components may be damaged. One method commonly employed to address this problem is the use of conductive footwear. By wearing a pair of conductive shoes, the person testing the electronic products is electrically grounded and the static charge is therefore eliminated. Various tests have shown that conductivity, more specifically, the impedance of a conductive shoe must be maintained within a certain range. One company in the computer and electronics industry recommends that the impedance of a conductive shoe be maintained within 10⁶ ohms to 10⁷ ohms. Other forms of grounding have been used to dissipate the electrostatic charge before it builds up to harmful levels. Such grounding measures include installing conductive or dissipative floors or stepping mats and/or wearing conductive wrist straps.

The efficacy of antistatic devices such as footwear, wrist and heel straps, etc. is typically determined by the electrical resistance of the conducting surface of the device in ohms. This electrical resistance may be affected by various environmental factors, such as humidity, dirt and other contamination, wear and other damage. A variable or unreliable electrical resistance does not provide continuous and reliable protection, as required in many environments with components sensitive to relatively small electrostatic discharges.

There remains, therefore, a need for footwear with improved electrostatic discharge properties that overcomes the limitations, shortcomings and disadvantages of the previous approaches.

### SUMMARY OF THE INVENTION

The invention meets the identified needs, as well as other needs, as will be more fully understood following a review of this specification and drawings.

One embodiment of the invention comprises an electrostatic circuit for a sole having a conductive outsole, a conductive insole and a nonconductive midsole positioned between the insole and outsole. This embodiment of the electrostatic circuit includes a first substrate that has a first end and a second end. In one embodiment, the substrate is flexible and in another embodiment, the substrate may be relatively rigid and inflexible. The electrostatic circuit may further include at least one conductor path that is attached to the first substrate. Each conductor path has a first exposed end that is adjacent to the first end of the first substrate and that is attachable to the conductive outsole. Each conductor path also has a second exposed end that is adjacent to the second end of the substrate and that is attachable to the conductive insole. In addition, the circuit includes at least one resistor that is electrically coupled to each conductor path and mounted to the first substrate.

Another embodiment of the present invention includes an electrostatic circuit for a sole that has a conductive outsole, a conductive insole and a nonconductive midsole between the insole and outsole. In this embodiment, the electrostatic circuit includes a first substrate that has a first end and a second end. A first conductor path is attached to the first substrate. The first conductor path has a first exposed end that is adjacent to the first end of the first substrate and that is attachable to the conductive outsole. The first conductor path also has a second exposed end that is adjacent to the second end of the first substrate and that is attachable to the conductive insole. A first resistor is supported on the first substrate and is electrically coupled to the first conductor path. In addition, a second conductor path is attached to the first substrate. The second conductor path has a second exposed end that is adjacent to the first end of the first substrate and that is attachable to the conductive outsole. The second conductor path also has a second exposed end that is adjacent to the second end of the first substrate and that is attachable to the conductive insole. A second resistor is supported on the first substrate and is electrically coupled to the second conductor path. A third conductor path is attached to the first substrate. The third conductor path has a first exposed end that is adjacent to the first end of the first substrate and is attachable to the conductive outsole. The third conductive path also has a second exposed end that is adjacent to the second end of the substrate and that is attachable to the conductive insole. A third resistor is supported on the first substrate and is electrically coupled to the third conductor path.

Another embodiment of the present invention comprises a sole for a conductive shoe. The sole includes a conductive outsole and a midsole that is adjacent to the outsole. A conductive insole is adjacent to the midsole. The sole further includes a printed circuit that comprises a first substrate and at least one conductor path that is attached to the first substrate. Each conductor path has a first end that is attached to the conductive outsole and a second end that is attached to the conductive insole. At least one resistor is electrically coupled to each conductor path and mounted to the first substrate.

Yet another embodiment of the present invention comprises a method for applying a desired amount of electrical impendence to an electrostatic current passing through a shoe having a conductive outsole, a conductive insole and a nonconductive midsole between the outsole and insole. The method includes affixing one end of a first conductive path formed on a substrate to the conductive outsole and electrically coupling a first resistor having the desired amount of impedance to the conductive path. The method further includes affixing another end of the first conductive path to the conductive insole.

Another embodiment of the present invention comprises a method of manufacturing a sole for a conductive shoe. The method includes affixing a first conductive path to a substrate such that the first conductive path has a first exposed end and a second exposed end and attaching a first resistor to the first conductive path. The method also includes forming a conductive outsole and a nonelectrically conductive midsole and supporting the nonelectrically conductive midsole on the electrically conductive outsole. The method further includes forming an electrically conductive insole and supporting the electrically conductive insole to the nonelectrically conductive midsole. The substrate is supported within the midsole such that the first exposed end of the first conductive path is in electrical contact with the electrically conductive outsole and the second end of the first electrically conductive path is in electrical contact with the electrically conductive insole.

Other features and advantages of the invention will become apparent from the detailed description of the embodiments set forth herein and from the appended claims.

### BRIEF DESCRIPTION OF THE DRAWINGS

In the accompanying Figures, there are shown present embodiments of the invention wherein like reference numerals are employed to designate like parts and wherein:

FIG. 1 is a side elevational view of an item of footwear with an embodiment of a sole of the present invention with portions of the sole shown in cross-section;

FIG. 2 is an enlarged partial view of the sole of FIG. 1 showing an orientation of one embodiment of a printed circuit of the present invention;

FIG. 3 is a cross-sectional assembly view of the sole of FIG. 1;

FIG. 4 is a top view of a midsole and a portion of a printed circuit of the present invention;

FIG. 5 is a top view of an embodiment of a printed circuit of the present invention;

FIG. 6 is a side elevational view of conductive paths of the printed circuit of FIG. 5;

FIG. 7 is a bottom view of the printed circuit of FIG. 5;

FIG. 8 is another top view of the printed circuit of FIG. 5, with a moisture barrier applied thereto; and

FIG. 9 is a cross-sectional exploded assembly view of the printed circuit of FIG. 8 taken along line IX-IX in FIG. 8.

### DETAILED DESCRIPTION OF THE INVENTION

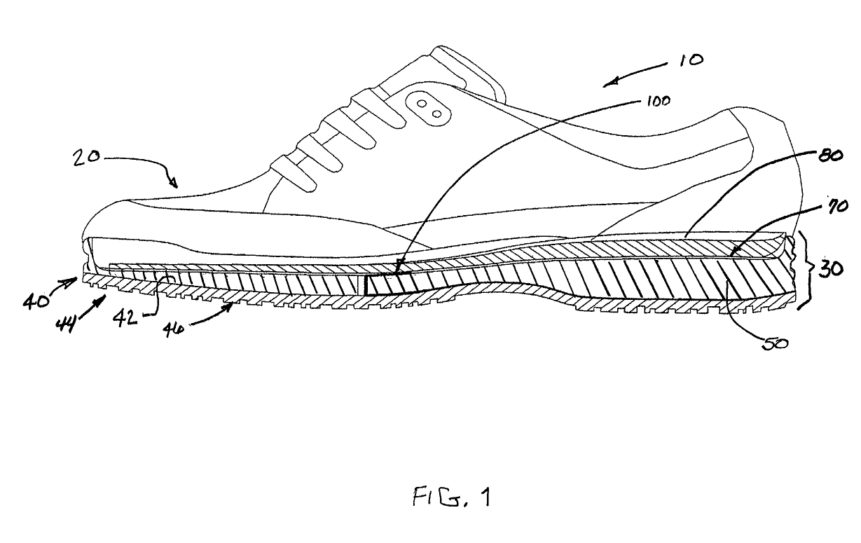

Referring now to the drawings for the purpose of illustrating the invention and not for the purpose of limiting the same, FIG. 1 illustrates an embodiment of the present invention in the form of an item of footwear 10 employing an embodiment of a flexible printed circuit 100 of the present invention. As the present Detailed Description of the Invention proceeds, those of ordinary skill in the art will appreciate that the flexible printed circuits 100 may be used in combination with a variety of different types of footwear without departing from the spirit and scope of the present invention. Thus, the protection afforded to the various embodiments of the present invention should not be limited to footwear having the specific cross-sectional shape and configuration depicted in FIG. 1.

As can be seen in FIG. 1, the item of footwear 10 includes an upper 20 that may be fabricated from a variety of materials such as canvas, leather, etc. The upper 20 may be attached to the sole assembly 30 by conventional footwear assembly processes and techniques. In this embodiment, the sole assembly 30 includes an electrically conductive outsole 40, a non-electrically conductive midsole 50, an electrically conductive insole 70 and an electrically conductive sock liner 80. In addition, as will be described in further detail below, a flexible circuit 100 is supported within the midsole 50 to define at least one electrically conductive path having a desired impedance that extends between the electrically conductive insole board 70 and the electrically conductive outsole 40. As used herein, the term “electrically conductive” refers to the ability to transmit an electrical current therethrough.

In this embodiment, the outsole 40 may be fabricated from a polyurethane or similar rubber material that is mixed with carbon powder utilizing known fabrication techniques and processes such that the outsole 40 will conduct an electrical current. In one embodiment, it is desirable for the outsole 40 to have a resistance value of less than 1×10⁶ ohms. However, the outsole 40 could conceivably be fabricated from other materials having similar electrically conductive characteristics. As can be seen in FIGS. 1 and 3, the outsole 40 has an upper surface 42 and a lower surface 44 that may have a tread pattern 46 formed thereon.

The midsole 50 of this embodiment may be fabricated from a non-conductive material such as polyurethane or EVA. As used herein, the term “non-conductive” means having an electrical impedance value that is greater than 1×10⁷ ohms. However, the midsole 50 may be fabricated from other suitable materials that essentially do not conduct electrical current. In one embodiment, the midsole 50 has a resistance that is greater than 1×10⁷ ohms. As can be seen in FIGS. 3 and 4, a cavity 52 is provided through the midsole 50 to enable the printed circuit 100 to extend therethrough and thereby be supported by the midsole 50 as will be discussed in further detail below. Also in this embodiment, the insole 70 and the conductive sock liner 80 may be fabricated from polyurethane or similar material that contains a carbon powder to provide these elements with the ability to conduct an electrical current. Also in this embodiment, the insole 70 and the sock liner 80 have a resistance value that is less than 1×10⁶ ohms. Thus, in this embodiment, the outsole 40 has an electrical impedance, the midsole 50 has an electrical impedance that is greater than the electrical impedance of the outsole 40, and the insole 70 has an electrical impedance that is less than the electrical impedance of the midsole.

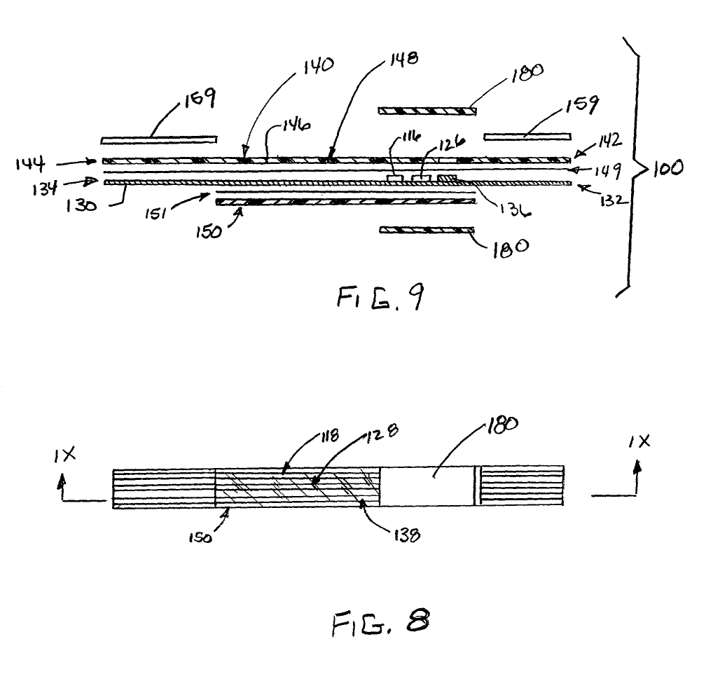

On embodiment of a printed circuit 100 of the present invention is depicted in FIGS. 5-9. In this embodiment, the printed circuit 100 includes at least one electrically conductive path or conductor path. As can be seen in FIGS. 5 and 6, this embodiment of the printed circuit 100 includes a first electrically conductive path 110, a second electrically conductive path 120 and a third electrically conductive path 130. The paths 110, 120, 130 may be formed from copper foil or similar material utilizing conventional chemical milling techniques. In this embodiment, the electrical conductive paths 110, 120, 130 may be approximately 25 μm thick. However, copper foil or similar materials having other thicknesses could conceivably be used.

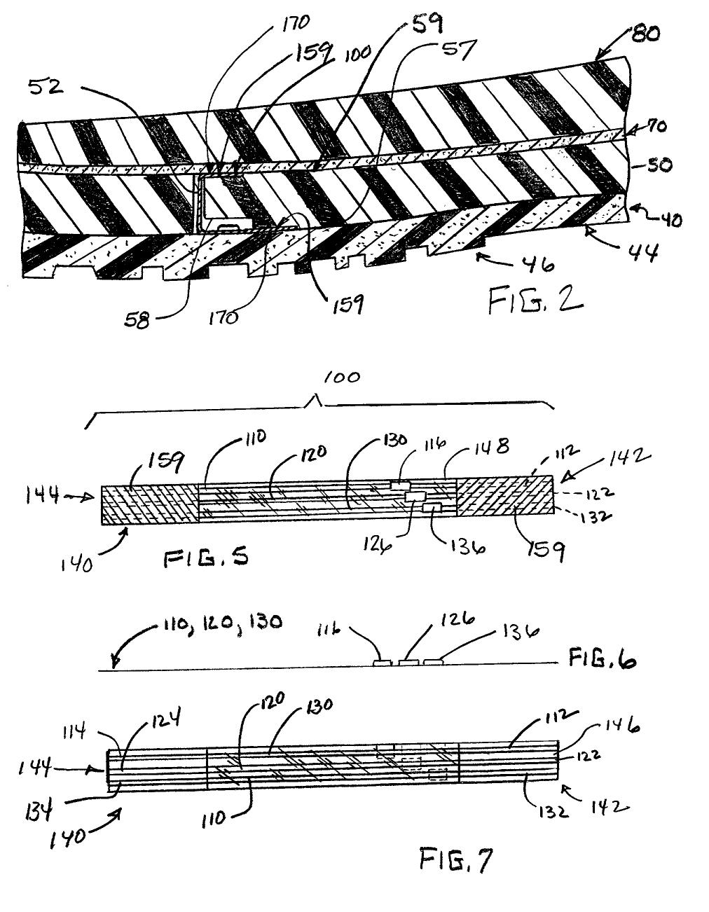

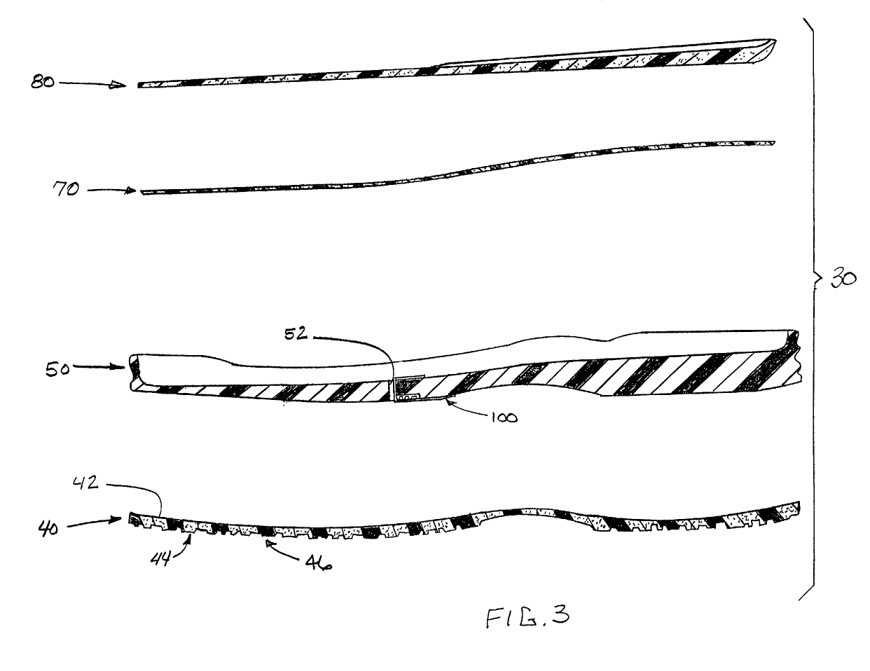

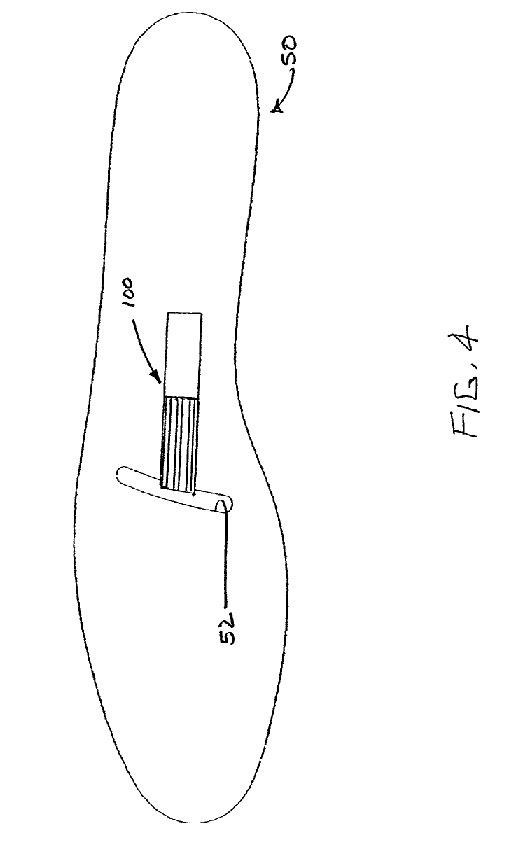

The electrically conductive paths 110, 120, 130 may be attached to a first substrate 140 with a commercially available adhesive 142 such as that adhesive supplied by King Her Chemical Industrial Corporation of No. 38, 18^{th} RD., Industrial Park, Taichung, Taiwan, R.O.C. However, other similar adhesives may be employed. In this embodiment, the first substrate may comprise a polyimide sheet material and having a thickness of 18 μm. However, other flexible sheet materials may also be used. The first substrate has a first end 142 and a second end 144 and a first side 146 and a second side 148. The first electrically conductive path 110, the second electrically conductive path 120 and the third electrically conductive path 130 are attached to the first side 146 of the first substrate 140 such that a first end 112 of the first path 110 is adjacent the first end 142 of the first substrate and the second end 114 of the first path 110 is adjacent the second end of the first substrate, the first end 122 of the second path is adjacent the first end 142 of the first substrate 140, the second end 124 of the second path 120 is adjacent the second end 144 of the first substrate 140, the first end 132 of the third path 130 is adjacent to the first end 142 of the first substrate 140 and the second end 134 of the third path 130 is adjacent to the second end 144 of the first substrate 140. See FIGS. 5 and 7. The paths 110, 120, 130 may be attached to the first side of 146 of the first substrate 140 by a layer of commercially available adhesive 149, such as that adhesive described above.

Also in this embodiment, a first resistor 116 is electrically coupled to the first path 110. A second resistor 126 is electrically coupled to the second path 120. A third resistor 136 is electrically coupled to the third path 130. The resistors 116, 126, 136 may comprise commercially available 6.8M-ohm resistors that extend through the first substrate 140 and are electrically coupled (soldered, etc.) to their respective path. In this embodiment, second substrate 150, in the form of polyimide sheet may be attached to the first side 146 of the first substrate and the central portions 118, 128, 138 of the first, second and third paths 110, 120, 130, respectively by a second layer of commercially available adhesive 151 of the type described above. In particular, the central portion 118 of the first path, the central portion 128 of the second path 120 and the central portion 138 of the third path are encapsulated between the first substrate 140 and the second substrate 150. The second substrate 150 is affixed to the first substrate 140 by a second layer of adhesive 152. As can be seen in FIGS. 5 and 7, the second substrate only covers the central portions of the paths such that the first ends 112, 122, 132, of the first, second and third paths 110, 120, 130, respectively are exposed. See FIG. 7. In this embodiment, the printed circuit 100 is assembled under pressure and may have an overall thickness of approximately 80-90 μm. An overall thickness of less than 3 mm should also work well. However, the printed circuit 100 may have a variety of other thicknesses that afford the circuit 100 the flexibility to be positioned within the sole assembly 30 as will be further discussed below. Thus, as used herein, the term “flexible” means that at least one portion of the circuit 100 may be bent or positioned relative to another position of the printed circuit such that those portions are not coplanar with respect to each other without damaging the printed circuit or its components (i.e., without hampering or destroying the ability of the first, second and third paths 110, 120, 130, respectively to conduct electrical current). The skilled artisan will appreciate that such construction enables the flexible printed circuit to be installed in a variety of advantageous configurations. It is conceivable, however, that the conductive paths 110, 120, 130, etc. may be affixed to a relatively rigid substrate that that has been preformed to a desired shape for installation in the manner described herein. Therefore, while the flexible substrates and circuits described herein are capable of flexing with the sole, it is conceivable that rigid substrates could also be employed. Thus, the protection afforded to the printed circuit herein should not be limited to circuits formed on flexible substrates, but should also encompass rigid printed circuits.

As was described above, the flexible printed circuit 100 is provided with three paths or conductors 110, 120, 130 that have a corresponding resistor 116, 126, 136 attached thereto. The total amount of resistance through the flexible printed circuit 100 is determined by the quantity and size of resistors employed. For example, the total impedance for the three 6.8M ohm resistors may be calculated as follows:

$$\frac{R1 \times R2 \times R3}{R1 \times R2 + R1 \times R3 + R2 \times R3} = 2.267 M ohms = 2.267 \times {10}^{6} ohms .$$

If one of the three resistors fails, the total impedance value for the flexible circuit board of this embodiment will be:

$$\frac{R1 \times R2}{R1 + R2} = 3.4 M ohms = 3.4 \times {10}^{6} ohms .$$

As indicated above, at least one major company in the computer industry recommends that the impedance of a conductive shoe be maintained within 10⁶ ohms to 10⁷ ohms. Thus, in this embodiment, even if two resistors fail, the total impedance value will be at 6.8×10⁶ ohms, which is still below the upper limit of 10⁷ ohms.

Those of ordinary skill in the art will appreciate that the impedance of the flexible circuit board may be varied by altering the number of paths (conductors) and resistors to achieve a desired amount of impedance in accordance with standard electrical engineering formulas (i.e., “Ohm's Law”). For example, series arrays or combination arrays may be used and their total impedance may be calculated as follows:

One Resistor:

R(total resistance value)=R1

Two Resistors (Combination Arrays):

$$R ( total resistance value ) = \frac{R1 \times R2}{R1 + R2}$$

Three Resistors (Combination Arrays):

$$R ( total resistance value ) = \frac{R1 \times R2 \times R3}{R1 \times R2 + R1 \times R3 + R2 \times R3}$$

Series Arrays:

R(total resistance value)=R1+R2+R3+ . . .

In this embodiment, a moisture resistant barrier 180 may be wrapped over the resistors 116, 126, 136 to retard and prevent the infiltration of moisture into the points where the resistors 11, 126, 136 are coupled to the paths 110, 120, 130, respectively. The moisture barrier 180 may comprise a wrapping of conventional electrical insulation tape. However, the moisture resistant barrier 180 may be formed with other materials such as sealant, glue or the like.

The flexible printed circuit 100 may be installed in the footwear as shown in FIGS. 1, 2, 3 and 4. As can be seen in FIGS. 2 and 4, the midsole 50 has a hole or passageway 52 therethrough sized to receive a portion of the flexible circuit 100. In addition, an undercut 58 area may be provided in the bottom surface 57 of the midsole 50 to accommodate the resistors 116, 126, 136 when the circuit 100 is supported in the midsole 50 as shown. See FIG. 2. As can be seen, such arrangement permits the circuit 100 to be oriented such that the first end 112 of the first path 110, the second end 122 of the second path 120 and the third end 132 of the third path 130 to be in electrical contact with the conductive outsole 40 to transmit electrical current thereto. Similarly, the second end 114 of the first path 110 and the second end 124 of the second path 120 and the second end 134 of the third path 130 are supported in electrical contact with the conductive insole board 70 to receive electrical current therefrom. If desired, the first end 142 of the circuit 100 may be attached to the underside 57 of the midsole with double-sided adhesive tape 159. A variety of different types of adhesives or adhesive tapes may be used. For example, the double-sided tape manufactured by the 3M Company under Model No. 467 may be employed. Similarly, the second end 144 of the circuit 100 may be affixed to the upper surface 59 of the midsole by another section of such double-sided adhesive tape 159. The reader will appreciate that when the flexible circuit 100 is installed as shown in FIGS. 1, 2, 3, and4, the exposed ends 112, 122, 132,ofthepaths 110, 120, 130, respectively remain exposed to contact the conductive outsole 40 and the exposed ends 114, 124, 134 of the paths 110, 120, 130, respectively are exposed to contact the conductive insole board 70. In this embodiment, the end 142 of the flexible circuit 100 that contains the exposed ends 112, 122, 132 may be fastened to the outsole 40 with commercially available ESD conductor glue 170 that has a resistance range of 5×10⁴˜10⁶ Ohms. The midsole 50 is attached to the outsole 40 by commercially available conductive cement. Similarly, the insole board 70 is attached to the midsole 50 by commercially available conductive cement. In this embodiment, the sock liner is not attached to the insole board. Thus, when installed as shown in FIGS. 1 and 2, the exposed ends 114, 124, 134 of the paths 110, 120, 130, respectively contact the conductive insole board 70 and the flexible circuit 100 extends through the opening 52 in the midsole 50 and the exposed ends 112, 122, 124 of the paths 110, 120, 130, respectively, contact the conductive outsole 40. Therefore, such arrangement permits a static charge to pass from the foot through the conductive sock liner 80, through the conductive insole board 70, through the paths 110, 120, 130 and resistors 116, 126, 136 to provide an impedance of 2.267×10⁶ ohms. This charge then passes from the paths 110, 120, 130 to the conductive outsole 40 such that the charge is safely dissipated to the floor surface. In this embodiment, by way of example only, the impedance of the respective parts of the sole assembly is: sock liner 80: 2.5×10⁴-2×10⁵ ohms; insole board 70: 10⁴-10⁵ ohms; resistors 116, 126, 136: 6.8×10⁶ ohms (each); midsole 50: 10¹¹-10¹² ohms; conductive outsole 40: 10⁴-3×10⁴ ohms; and conductive adhesive: 10⁴-10⁵ ohms.

To test the effectiveness of the above-mentioned design, two different items of footwear manufactured in accordance with the above-mentioned embodiment of the present invention were tested as outlined below by Fowler Associates, Inc. of 3551 Moore-Duncan Highway, Moore, S.C. 29639:

Iron Age® Women's Style 492M, SIZE 7M Steel Toe Hiker

Test Methods: ANSI Z41-1999**, ESD S 9.1 and ESD DSTM 54.2 **These tests are in general agreement with ANSI Z41-1999 and according to ESD S9.1 and DSTM 54.2. ANSI-Z41 states 50% RH and voltage between 25 volts and 50 volts. These tests were performed at 10 volts and 100 volts at 12% RH. These conditions are more stringent than ANSI Z41.

Test Equipment: Dr. Thiedig MegOhm Meter Applied voltage: 10 vdc, 100 vdc, 500 vdc

Electrodes: 2½ in. aluminum cylinder, aluminum plate, aluminum foil

Laboratory conditions: 73° F., 12% RH

| | Resistance of Individual to Ground-Ohms | | | |
|---|---|---|---|---|
| | Laboratory conditions: 73° F., 12% | | | |
| | After 3 mins. of Wear | | After 5 mins. of Wear | |
| Test Sample | 10 v | 100 v | 10 v | 100 v |
| Style 492M | | | | |
| Both | 2.69 × 10⁶ | 1.83 × 10⁶ | 2.50 × 10⁶ | 1.73 × 10⁶ |
| Left | 4.23 × 10⁶ | 3.18 × 10⁶ | 4.15 × 10⁶ | 3.13 × 10⁶ |
| Right | 4.43 × 10⁶ | 3.41 × 10⁶ | 4.23 × 10⁶ | 3.35 × 10⁶ |

| | Resistance of Shoe to Ground per ESD S9.1-Ohms |
|---|---|
| | 25 lbs. lead shot in Shoe |
| Test Sample | 100 v |
| Style 492M | |
| Left | 4.17 × 10⁶ |
| Right | 4.81 × 10⁶ |

Iron Age® Women's Style 492M, SIZE 6M Steel Toe Hiker

Test Methods: ANSI Z41-1999**, ESD S 9.1 and ESD DSTM 54.2 **These tests are in general agreement with ANSI Z41-1999 and according to ESD S9.1 and DSTM 54.2. ANSI-Z41 states 50% RH and voltage between 25 volts and 50 volts. These tests were performed at 10 volts and 100 volts at 12% RH. These conditions are more stringent than ANSI Z41.

Test Equipment: Dr. Thiedig MegOhm Meter Applied voltage: 10 vdc, 100 vdc, 500 vdc

Electrodes: 2½ in. aluminum cylinder, aluminum plate, aluminum foil

Laboratory conditions: 73° F., 12% RH

| | Resistance of Individual to Ground-Ohms | | | |
|---|---|---|---|---|
| | Laboratory conditions: 73° F., 12% | | | |
| | After 3 mins. of Wear | | After 5 mins. of Wear | |
| Test Sample | 10 v | 100 v | 10 v | 100 v |
| Style 492M | | | | |
| Both | 2.32 × 10⁶ | 1.44 × 10⁶ | 2.21 × 10⁶ | 1.47 × 10⁶ |
| Left | 3.86 × 10⁶ | 2.80 × 10⁶ | 3.87 × 10⁶ | 2.88 × 10⁶ |
| Right | 3.49 × 10⁶ | 2.56 × 10⁶ | 3.40 × 10⁶ | 2.55 × 10⁶ |

| | Resistance of Shoe to Ground per ESD S9.1-Ohms |
|---|---|
| | 25 lbs. lead shot in Shoe |
| Test Sample | 100 v |
| Style 492M | |
| Left | 4.12 × 10⁶ |
| Right | 3.01 × 10⁶ |

**These test are in general agreement with ANSI Z41-1999 and according to ESD S9.1 and DSTM 54.2. ANSI-Z41 states 50% RH and voltage between 25 volts and 50 volts. These test were performed at 10 volts and 100 volts at 12% RH. These conditions are more stringent than ANSI Z41.

Iron Age® Women's Style 492M, SIZE 6M Steel Toe Hiker

Test Methods: ANSI Z41-1999**, ESD S 9.1 and ESD DSTM 54.2 **These tests are in general agreement with ANSI Z41-1999 and according to ESD S9.1 and DSTM 54.2. ANSI-Z41 states 50% RH and voltage between 25 volts and 50 volts. These tests were performed at 10 volts and 100 volts at 12% RH. These conditions are more stringent than ANSI Z41.

Test Equipment: Dr. Thiedig MegOhm Meter Applied voltage: 10 vdc, 100 vdc, 500 vdc

Electrodes: 2½ in. aluminum cylinder, aluminum plate, aluminum foil

Laboratory conditions: 73° F., 12% RH

| | Resistance of Individual to Ground-Ohms | | | |
|---|---|---|---|---|
| | Laboratory conditions: 73° F., 50% | | | |
| | After 3 mins. of Wear | | After 5 mins. of Wear | |
| Test Sample | 10 v | 100 v | 10 v | 100 v |
| Style 492M | | | | |
| Both | 3.48 × 10⁶ | 1.50 × 10⁶ | 3.25 × 10⁶ | 1.60 × 10⁶ |
| Left | 5.16 × 10⁶ | 2.84 × 10⁶ | 4.22 × 10⁶ | 3.05 × 10⁶ |
| Right | 5.26 × 10⁶ | 2.90 × 10⁶ | 4.05 × 10⁶ | 2.96 × 10⁶ |

| | Resistance of Shoe to Ground per ESD S9.1-Ohms |
|---|---|
| | 25 lbs. lead shot in Shoe |
| Test Sample | 100 v |
| Style 492M | |
| Left | 3.21 × 10⁶ |
| Right | 2.78 × 10⁶ |

As can be appreciated from the foregoing description, the various embodiments of the present invention represent a vast improvement over prior footwear designs that are constructed to dissipate static electricity. In particular, the flexible circuit board embodiments of the present invention are relatively compact and require minimal space to install. Furthermore, because they are flexible, they are not as susceptible to damage as the conventional resistors used in other shoe designs. The resistors provide a series of load bearing contact surfaces for more uniform distribution of the weight pressure from the insole to the outsole, and thus result in reduction of the pressure in each resistor. The impendence dimensions of the resistors employed by the present invention are generally smaller and more stable than such prior resistor arrangements and, therefore, they can typically resist more pressure. Furthermore, if one or two of the resistors of the present invention fail, the total impedance value will be below 10⁷ ohms. Furthermore, because the flexible circuit board determines the major part of the impedance of the sole, the impendence of the sole materials employed is less critical. Therefore a wider range of materials can be used to fabricate the sole. Manufacturing costs can thus be greatly reduced without affecting quality requirement because the impedance of the resistor components in the midsole is very stable and will not change in a wet environment such as perspiration from the wearer's foot or a wet floor surface, the total impedance of the sole can still be maintained within a desired range of impedance.

Whereas particular embodiments of the invention have been described herein for the purpose of illustrating the invention and not for the purpose of limiting the same, it will be appreciated by those of ordinary skill in the art that numerous variations of the details, materials and arrangement of parts may be made within the principle and scope of the invention without departing from the invention as described in the appended claims.

What is claimed is:

1. An electrostatic circuit for a sole having an outsole, an insole and a midsole positioned between the insole and outsole, said electrostatic circuit comprising:
a first substrate having a first end and a second end;
at least one conductor path attached to said first substrate, each said conductor path having a first exposed end adjacent said first end of said first substrate and being attachable to the outsole and a second exposed end adjacent said second end of said substrate and attachable to the insole; and
at least one resistor electrically coupled to each said conductor path and mounted to said first substrate.

2. The electrostatic circuit of claim 1 wherein said first substrate is flexible and extends through an opening in the midsole.

3. The electrostatic circuit of claim 1 further comprising a second substrate attached to said first substrate such that a central portion of each said conductor path is encapsulated between said first and second substrates, said second substrate not covering said first and second ends of each said conductor path.

4. The electrostatic circuit of claim 3 further comprising a moisture barrier wrapped around a portion of said first and second substrates and covering said resistors.

5. The electrostatic circuit of claim 1 wherein said first and second exposed ends of each said conductor path are adjacent a first side of said first substrate and wherein said electrostatic circuit further comprises a first adhesive attached to a second side of said first substrate adjacent said first and second ends thereof.

6. The electrostatic circuit of claim 5 further comprising a second adhesive for affixing said first end of each said conductor path to the outsole and said second end of each said conductor path to the insole.

7. The electrostatic circuit of claim 1 wherein the total impedance provided by said resistors is less than or equal to 10⁷ ohms.

8. The electrostatic circuit of claim 1 wherein said first substrate is flexible.

9. The electrostatic circuit of claim 8 wherein said first substrate is fabricated from a polyimide sheet material having a thickness of approximately 25 μm.

10. An electrostatic circuit for a sole having a conductive outsole, a conductive insole and a nonconductive midsole between the insole and outsole, said electrostatic circuit comprising:
a first substrate having a first end and a second end;
a first conductor path attached to said first substrate, said first conductor path having a first exposed end adjacent said first end of said first substrate and being attachable to the conductive outsole and a second exposed end adjacent said second end of said first substrate and attachable to the conductive insole;
a first resistor supported on said first substrate and electrically coupled to said first conductor path;
a second conductor path attached to said first substrate, said second conductor path having a first exposed end adjacent said first end of said first substrate and being attachable to the conductive outsole and a second exposed end adjacent said second end of said first substrate and attachable to the conductive insole;
a second resistor supported on said first substrate and electrically coupled to said second conductor path;
a third conductor path attached to said first substrate, said third conductor path having a first exposed end adjacent said first end of said first substrate and being attachable to the conductive outsole and a second exposed end adjacent said second end of said substrate and attachable to the conductive insole; and
a third resistor supported on said first substrate and electrically coupled to said third conductor path.

11. The electrostatic circuit of claim 10 wherein said first substrate is flexible and extends through an opening in the nonconductive midsole.

12. The electrostatic circuit of claim 10 further comprising a second substrate attached to said first substrate such that a central portion of each said first, second and third conductor paths is encapsulated between said first and second substrates, said second substrate not covering said first and second ends of each said first, second and third conductor paths.

13. The electrostatic circuit of claim 12 further comprising a moisture barrier wrapped around a portion of said first and second substrates and covering said first, second and third resistors.

14. The electrostatic circuit of claim 10 wherein said first and second exposed ends of each said first, second and third conductor paths are adjacent a first side of said first substrate and wherein said electrostatic circuit further comprises a first adhesive attached to a second side of said first substrate adjacent said first and second ends thereof.

15. The electrostatic circuit of claim 14 further comprising a second adhesive for affixing each said first end of said first second and third conductor paths to the conductive outsole and each said second end of said first, second and third conductor paths to the conductive insole.

16. A sole for a conductive shoe, said sole comprising:
an outsole;
a midsole adjacent said outsole;
an insole adjacent said midsole; and
a printed circuit comprising:
a first substrate;
at least one conductor path attached to said first substrate, each said conductor path having a first end attached to said outsole and a second end attached to said insole; and
at least one resistor electrically coupled to each said conductor path and mounted to said first substrate.

17. The sole of claim 16 wherein said first substrate is flexible and extends through an opening through a portion of said midsole.

18. The sole of claim 17, further comprising an undercut area in said midsole adjacent said opening, said undercut area sized to accommodate at least a portion of at least one of said resistors therein.

19. The sole of claim 16 further comprising a sock liner adjacent said insole.

20. The sole of claim 16 wherein said outsole is fabricated from material selected from the group consisting of polyurethane and rubber.

21. The sole of claim 16 wherein said outsole has an electrical resistance value of less than 1×10⁶ ohms.

22. The sole of claim 16 wherein said midsole is fabricated from material selected from the group of polyurethane and EVA.

23. The sole of claim 16 wherein said midsole has an electrical resistance value of greater than 1×10⁷ ohms.

24. The sole of claim 16 wherein one side of said outsole has a tread pattern thereon.

25. The sole of claim 16 wherein said insole is fabricated from polyurethane and carbon powder.

26. The sole of claim 16 wherein said insole has an electrical resistance value of less than 1×10⁶ ohms.

27. The sole of claim 19 wherein said sock liner is fabricated from polyurethane and carbon powder.

28. The sole of claim 16 wherein said sock liner has a resistance value of less than 1×10⁶ ohms.

29. The sole of claim 17 wherein said flexible substrate comprises a polyimide sheet material.

30. A sole for a conductive shoe, said sole comprising:
an outsole having an electrical resistance value of less than 1×10⁶ ohms;
a midsole adjacent said outsole and having an electrical resistance value of greater than 1×10⁷ ohms;
an insole adjacent said midsole and having an electrical resistance value of less than 1×10⁶ ohms; and
a printed circuit comprising:
a first substrate;
at least one conductor path attached to said first substrate, each said conductor path having a first end attached to said outsole and a second end attached to said insole; and
at least one resistor electrically coupled to each said conductor path and mounted to the first substrate.

31. The sole of claim 30 further comprising a sock liner adjacent said insole and having an electrical resistance value of less than 1×10⁶ ohms.

32. A sole for an item of footwear, said sole comprising:
an outsole having a predetermined electrical impedance;
a midsole adjacent to said outsole and having a predetermined electrical impedance that is greater than said predetermined electrical impedance of said outsole;
an insole adjacent said midsole and having a predetermined electrical impedance that is less than said predetermined electrical impedance of said midsole;
a substrate extending between said outsole and said insole;
a conductor on said substrate and having one end attached to said outsole and another end attached to said insole; and
a resistor attached to said conductor.

33. The sole of claim 32 further comprising a sock liner adjacent said insole and having a predetermined electrical impedance that is less than said predetermined electrical impedance of said midsole.

34. A method for applying a desired amount of electrical impendence to an electrostatic current passing through a shoe having an outsole, an insole and a midsole between the outsole and insole, said method comprising:
affixing one end of a first conductive path formed on a substrate to the outsole;
electrically coupling a first resistor having the desired amount of impedance to the conductive path; and
affixing another end of the first conductive path to the insole.

35. The method of claim 34, further comprising:
affixing one end of a second conductive path formed on the substrate to the outsole;
electrically coupling a second resistor to the second conductive path, the first and second resistors providing the desired amount of impedance; and
affixing another end of the second conductive path to the insole.

36. The method of claim 35, further comprising:
affixing one end of a third conductive path formed on the substrate to the outsole;
electrically coupling a third resistor to the third conductive path, the first, second and third resistors providing the desired amount of impedance; and
affixing another end of the third conductive path to the insole.

37. The method of claim 34 wherein said affixing one end of the first conductive path comprises attaching the one end of the first conductive path to the outsole with a conductive adhesive and wherein said affixing another end of the first conductive path to the insole comprises attaching the another end of the first conductive path to the insole with conductive adhesive.

38. The method of claim 35 wherein said affixing one end of the second conductive path comprises attaching the one end of the second conductive path to the outsole with a conductive adhesive and wherein said affixing another end of the second conductive path to the insole comprises attaching t he another end of the second conductive path to the insole with conductive adhesive.

39. The method of claim 36 wherein said affixing one end of the third conductive path comprises attaching the one end of the third conductive path to the outsole with a conductive adhesive and wherein said affixing another end of the third conductive path to the insole comprises attaching the another end of the third conductive path to the insole with conductive adhesive.

40. The method of claim 34 further comprising extending a portion of the substrate through a portion of the midsole.

41. A method of manufacturing a sole for a conductive shoe, comprising:
affixing a first conductive path to a substrate such that the first conductive path has a first exposed end and a second exposed end;
attaching a first resistor to the first conductive path;
forming a conductive outsole;
forming a non-electrically conductive midsole;
supporting the nonelectrically conductive midsole on the electrically conductive outsole;
forming an electrically conductive insole;
attaching the electrically conductive insole to the non-electrically conductive midsole; and
supporting the substrate within the midsole such that the first exposed end of the first conductive path is in electrical contact with the electrically conductive outsole and the second end of the first electrically conductive path is in electrical contact with the electrically conductive insole.

42. The method of claim 41 further comprising:
affixing the first exposed end of the first electrically conductive path to the electrically conductive outsole; and
affixing the second exposed end of the first electrically conductive path to the electrically conductive insole.

43. The method of claim 41 further comprising:
affixing a second conductive path to the substrate such that the second conductive path has a first exposed end and a second exposed end; and
attaching a second resistor to the second conductive path, said substrate supported within said midsole such that the first ends of the first and second electrically conductive paths are in contact with the electrically conductive outsole and the second ends of the first and second electrically conductive paths are in contact with the electrically conductive insole.

44. The method of claim 43 further comprising:
affixing the first exposed ends of the first and second electrically conductive paths to the electrically conductive outsole; and
affixing the second exposed ends of the first and second electrically conductive paths to the electrically conductive insole.

45. The method of claim 43 further comprising:
affixing a third conductive path to the substrate such that the third conductive path has a first exposed end and a second exposed end; and
attaching a third resistor to the third conductive path, the substrate supported within said midsole such that the first ends of the first, second and third electrically conductive paths are in contact with the electrically conductive outsole and the second ends of the first, second and third electrically conductive paths are in contact with the electrically conductive insole.

46. The method of claim 45 further comprising:
affixing the first exposed ends of the first, second and third electrically conductive paths to the electrically conductive outsole; and
affixing the second exposed ends of the first, second and third electrically conductive paths to the electrically conductive insole.
